(19) United States
(12) Patent Application Publication
(10) Pub. No.: US 2008/0300362 A1
(43) Pub. Date: Dec. 4, 2008

(54) Application And Preparation For The Composite Electrolyte Based On Superabsorbent Hybrid

(75) Inventors: Jihuai Wu, Fujian (CN); Sancun Hao, Fujian (CN); Zhang Lan, Fujian (CN); Jianming Lin, Fujian (CN); Yuelin Wei, Fujian (CN)

Correspondence Address: ERIC CHAN, 42 PIN OAKS DRIVE, PHOENIXVILLE, PA, 19460, US

(73) Assignee: HUA QIAO UNIVERSITY, Fujian (CN)

(21) Appl. No.: 11/814,077

(22) PCT Filed: Jan. 31, 2005
(86) PCT No.: PCT/CN05/00129

§ 371 Date: Jul. 16, 2007

(51) Int. Cl. C08K 5/18; C08L 33/00

(52) U.S. Cl. 524/722; 524/853

(57) ABSTRACT

The invention discloses the preparation method of one kind of composite electrolyte with high conductivity and good stability. In detail, using a superabsorbent hybrid as matrix, organic compounds with high dielectric constant as solvent, inorganic compounds as ion donor, the composite electrolyte is prepared by self-cross linking and thermosetting reaction. The electrolyte can be used in dye-sensitized solar cell as carrier transferring medium, and also used in window material, solid-state secondary cell, electroluminescence, sensor, and so on.

The application and preparation for the composite electrolyte based on superabsorbent hybrid

### BACKGROUND OF THE INVENTION

The present invention relates to the application and methods of a composite electrolyte based on superabsorbent hybrid, it is classified as the field of new material technique and new energy source.

As a new type of photochemical solar cell, dye-sensitized solar cell (DSSC) was firstly invented in 1991. The dye-sensitized solar cell has low cost, simple production technology, good long-term stability and friendly environment compatibility, which give it a great application prospect. The dye-sensitized solar cell is mainly based on a liquid electrolyte at present, however, the potential problems for liquid electrolyte in packaging, leakage and volatilization make the dye-sensitized solar cell a bad long-term stability and impractical application. So it is inevitable that the liquid electrolyte is substituted by solid-state electrolyte or gel electrolyte for dye-sensitized solar cell.

### DETAILED DESCRIPTION OF THE INVENTION

The motive of this invention is to disclose the methods and application of a composite electrolyte based on superabsorbent hybrid with high conductivity and good stability.

The technical project of the invention is described as follow: The composite electrolyte is based on superabsorbent hybrid, organic compounds with high dielectric constant are used as solvent, inorganic salts are added as ion donors, the composite electrolyte is fabricated by self-cross linking and thermosetting techniques.

The preparation method of the composite electrolyte based on superabsorbent hybrid is described as follows:

The first step, the purification of organic solvents with high dielectric constant: commercial organic solvents are purified by reduced pressure distillation technique.

The second step, the mixing of organic solvent and inorganic ion donors: the inorganic ion donors are added into the organic solvent prepared in the first step, the concentration of inorganic ions donor is from 1.0 to 2.0 mol/L, and then the mixture is refluxed till the inorganic ion donors are dissolved completely in organic solvent.

The third step, the preparing of the superabsorbent hybrid matrix: the commercial acrylic monomer is neutralized by potassium hydroxide, and the mole ratio for acrylic monomer and potassium is from 0.8 to 1.0, and then added to the solution prepared in the second step, finally, the certain catalytic agent is added. The volume ratio between the solution prepared in step two, catalytic agent and neutralizing acrylic monomer is from 0.5:0.1:1 to 0.8:0.3:1. the mixture is refluxed to react in a water bath at 80 to 90° C. for thirty to sixty minutes, and then cools down to room temperature. After stirring for two to four hours, the superabsorbent hybrid matrix is prepared.

The fourth step the preparation of the composite electrolyte: the superabsorbent hybrid matrix prepared in step three is subjected to solidify at 60 to 80° C. for twelve to twenty-four hours, and then the polymer electrolyte is obtained.

The organic solvents with high dielectric constant are propylene carbonate, ethylene carbonate.

The inorganic ion donors are potassium iodide, or lithium iodide, or sodium iodide, or cupric iodide, or iodine.

The catalyzers and additives agents are phenylamine.

The resulted composite electrolyte can be used in dye-sensitized solar cell.

The superabsorbent hybrid possesses a three-dimension network structure interiorly by its self-cross linking reaction, which makes it can absorb a large volume of solvent and certain ions, and shows solid-state or quasi-solid-state. On the other hand, the ions in solvent combined with three-dimension network have mobility like in solvent, the high carrier concentration and ion mobility can be obtained. Basing on these characters, the composite electrolyte has a high conductivity and can substitute liquid electrolyte used as carrier transfers medium in dye-sensitized solar cell. The potential problems for liquid electrolyte in packaging, leakage and volatilization can be completely solved by using the composite electrolyte, the practical application of dye-sensitized solar cell based on the composite electrolyte can be achieved. The composite electrolyte also can be used in window material, solid-state secondary cell, electroluminescence, sensors, and so on.

### A Actualize Example

The composite electrolyte based on superabsorbent hybrid as matrix, organic compounds with high dielectric constant as solvent, inorganic salts as ion donors, is prepared by self-cross linking and thermosetting techniques.

The preparation methods of the composite electrolyte based on superabsorbent hybrid is described in detail as follows:

The first step, the purification of organic compounds: commercial propylene carbonate are purified by reduced pressure distillation technique.

The second step, the mixing of propylene carbonate and potassium iodide: potassium iodide is added into propylene carbonate prepared in the first step, the concentration of potassium iodide is from 1.0 to 2.0 mol/L, and then the mixture is refluxed in an oil bath at 80 to 90° C. for twenty hours till potassium iodide is dissolved completely in propylene carbonate.

The third step, the preparing of the superabsorbent hybrid matrix: the 100 ml of commercial acrylic monomer with the analytical purity is neutralized by 82 g of potassium hydroxide, and then added to 30 ml of the solution prepared in the second step, finally, 5 ml of phenylamine is added. the mixture is refluxed to react in a water bath at 80 to 90° C. for thirty to sixty minutes, and then cools down to room temperature. After stirring for two to four hours, the superabsorbent hybrid matrix is prepared and conserved at 0° C.

The fourth step the preparation of the composite electrolyte: the superabsorbent hybrid matrix prepared in step three is subjected to solidify at 60 to 80° C. for twelve to twenty-four hours, and then the polymer electrolyte is obtained.

The application of composite electrolyte in dye-sensitized solar cell: The composite electrolyte prepared in the third step is daubed on the electrode of dye-sensitized TiO₂ film by the common preparing technique of dye-sensitized solar cell, and then the counter electrode is assembled on the composite electrolyte, the counter electrode and the dye-sensitized TiO₂ film are tightly clamped together with certain pressure. After cleaning superfluous superabsorbent hybrid matrix, the cell is packaged and keeps at 60° C. for 12-24 h, which makes superabsorbent hybrid matrix solidified. After cooled down to room temperature, the dye-sensitized solar cell based on the composite electrolyte is obtained.

In the invention, propylene carbonate can be substituted by ethylene carbonate, and potassium iodide can be substituted by lithium iodide, or sodium iodide, or cupric iodide, or I⁻/I₃⁻.

What is claimed is:

1. The characters of this composite electrolyte based on superabsorbent hybrid are: a superabsorbent hybrid as matrix, organic compounds with high dielectric constant as solvent, and inorganic compounds as ion donor, the composite electrolyte is fabricated by self-cross linking and thermosetting reaction with these ingredients.

2. The traits of the preparation methods of the composite electrolyte based on superabsorbent hybrid are realized by following steps:
The first step, the purification of organic solvents with high dielectric constant: commercial organic solvents are purified by reduced pressure distillation technique;
The second step, the mixing of organic solvent and inorganic ion donors: the inorganic ion donors are added into the organic solvent prepared in the first step, the concentration of inorganic ion donors is from 1.0 to 2.0 mol/L, and then the mixture is refluxed till the inorganic ion donors are dissolved completely in organic solvent;
The third step, the preparing of the superabsorbent hybrid matrix: the commercial acrylic monomer is neutralized by potassium hydroxide, and the mole ratio for acrylic monomer and potassium is from 0.8 to 1.0, and then added to the solution prepared in the second step, finally, the certain catalytic agent is added; the volume ratio between the solution prepared in step two, catalytic agent and neutralizing acrylic monomer is from 0.5:0.1:1 to 0.8:0.3:1;
the mixture is refluxed to react in a water bath at 80 to 90° C. for thirty to sixty minutes, and then cools down to room temperature; after stirring for two to four hours, the superabsorbent hybrid matrix is prepared;
The fourth step, the preparation of the composite electrolyte: the superabsorbent hybrid matrix prepared in step three is subjected to solidify at 60 to 80° C. for twelve to twenty-four hours, and then the polymer electrolyte is obtained.

3. The character of the organic solvent described in the claims 2: The organic solvents with high dielectric constant are propylene carbonate or ethylene carbonate.

4. The character of the inorganic compounds described in the claims 2: The inorganic ion donors are potassium iodide, or lithium iodide, or sodium iodide, or cupric iodide, or iodine.

5. The character of the catalyzers and additives agents described in the claims 2: The catalyzers and additives agents are phenylamine.

6. As presented in claims 1, the composite electrolyte can be used in dye-sensitized solar cell.
